(19) United States
(12) Patent Application Publication
(10) Pub. No.: US 2005/0230985 A1
(43) Pub. Date: Oct. 20, 2005

(54) Shovels and other implements with scalloped leading edges

(76) Inventor: Richard Thiele JR., Plymouth, MI (US)

Correspondence Address: Gifford, Krass, Groh, Sprinkle,;Anderson & Citkowski, P.C., Suite 400, 280 N. Old Woodward Ave., Birmingham, MI, 48009-5394, US

(21) Appl. No.: 10/827,564

(22) Filed: Apr. 19, 2004

(51) Int. Cl. A01B 1/02

(52) U.S. Cl. 294/49

(57) ABSTRACT

An improved blade for a shovel includes a serrated leading edge having a plurality of concave scallops. In the preferred embodiments, the scallops are substantially identical and include a curved portion having a radius between two points spaced apart by a distance ‘d’, with the radius of each scallop, ‘r,’ being greater than d/2. In the preferred embodiments, the radius of each scallop, ‘r,’ is substantially equal to, or greater than, ‘d’. The invention finds utility in a variety of applications, including snow shoveling, gardening, ice scraping, and other material transfer, with optional ribs being provided for stiffening purposes. The leading edge and scoop portion may be separate and attached, and may be constructed from dissimilar materials.

### FIELD OF THE INVENTION

This invention relates generally to tools and, in particular, to hand tools such as shovels with improved performance.

### BACKGROUND OF THE INVENTION

It has been longed been recognized that, for some applications, certain tools should be provided with edges that are not the traditional flat or rounded shapes common with shovels, and the like. U.S. Pat. No. 2,988,926, entitled “Hoe,” for example, resides in a tool particularly adapted for cutting turf, digging ditch-banks, and similar work done in an earthy or peaty substance in which the decayed and decaying roots of grass and trees are frequently interspersed. According to this invention, the hoe is constructed with a concaved cutting edge, causing it to cut small roots and similar impediments which come between a pair of opposed outer points. A similar construction is found in U.S. Pat. No. D 407,955, entitled “Root Cutting Shovel.”

Other hand tools with unconventional blades have also been described with reference to garden shovels, shingle strippers, forks for litter and vegetables, harvesting, raking, weeding, and so forth. However, despite such advances, the need remains for an improved blade for use on various types of shovels and digging implements to provide improved performance.

### SUMMARY OF THE INVENTION

An improved blade for a shovel includes a serrated leading edge having a plurality of concave scallops. In the preferred embodiments, the scallops are substantially identically and sufficiently shallow so as not to defeat the scooping action or other work to be performed by the tool. In disclosed examples, the width of the scoop portion may range between 6 and 24 inches, and the number of scallops ranges between 3 and 12.

In terms of geometry, the scallops include a curved portion having a radius between two points spaced apart by a distance ‘d’, and the radius of each scallop, ‘r,’ is greater than d/2. In the preferred embodiments, the radius of each scallop, ‘r,’ is substantially equal to, or greater than, ‘d’. The invention may be adapted to a variety of applications, including snow shoveling, gardening, ice scraping, and other material transfer, with optional ribs being provided for stiffening purposes. The leading edge and scoop portion may be separate and attached, and may be constructed from dissimilar materials.

### BRIEF DESCRIPTION OF THE DRAWINGS

FIG. 1 is a drawing of a snow shovel embodiment according to the invention;

FIG. 2 is a drawing of a scoop-type shovel embodiment;

FIG. 3 is a drawing of a garden spade;

FIG. 4 is a drawing of a square-point shovel;

FIG. 5 is a drawing of an ice-scraper embodiment; and

FIG. 6 is a drawing which shows how a leading edge, according to the invention, may be assembled from multiple components, facilitating the use of dissimilar materials.

### DETAILED DESCRIPTION OF THE INVENTION

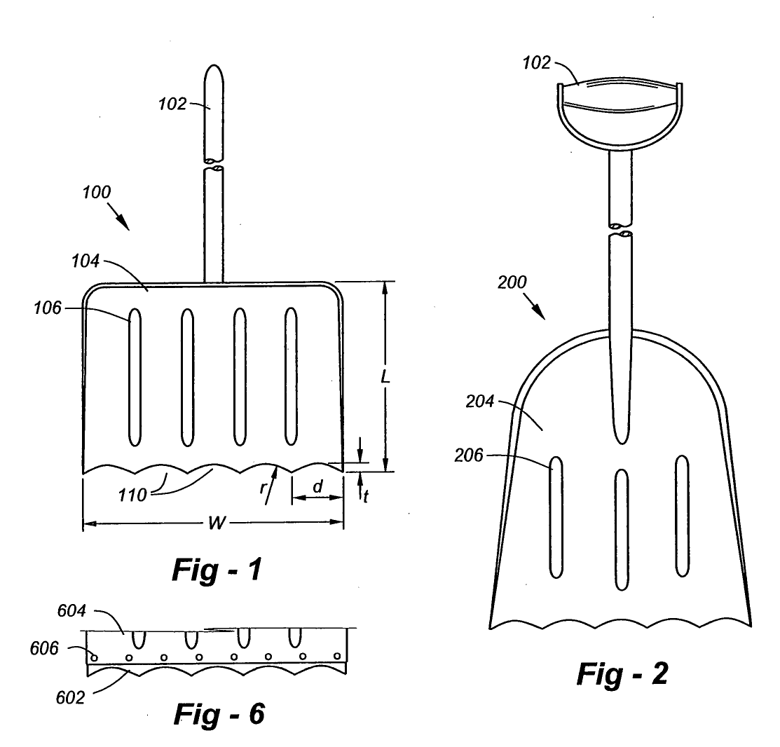

References now made to the drawings, FIG. 1 in particular, which illustrates an embodiment according to the invention, depicted generally at 100 that finds utility as a snow shovel. A tool includes a handle 102 which may be of any appropriate design, and a scoop portion 104 having a leading edge with scallops 110. Optional ribs 106 may be provided to afford additional strengthening.

In terms of dimensions, this being a snow-shovel embodiment, a scoop portion 104 preferably has a Width ‘W’ on the order of 20 inches, or thereabouts, and a Length ‘L’ on the order of 15 inches, or thereabouts. The invention is not limited in terms of these dimensions, however, such not for snow-shovel use, dimensions of L and W on the order of one foot to two feet, more or less, may be appropriate.

According to the invention, the leading edge of the scoop portion 104 includes a plurality of scallops, indicated at 110, each preferably having the same dimensions, and each preferably having a width ‘d’ on the order of four inches, or thereabouts, and a depth ‘t’, on the order of 0.75 inch, or thereabouts. Thus, in this particular preferred embodiment, the radius of the scalloped portions ‘r’ would be on the order of four inches.

Although five scallops are shown in the embodiment of FIG. 1, it would be appreciated that more or fewer scallops may be used, with the preferred number being between two and eight. The optimal number of scallops is a function of the width of the blade or scoop portion of the tool, with three scallops being more appropriate for narrower tools, as discussed with references 3-5. More important that the number of scallops is the radius used to defined the scallops is sufficiently large that the scallops are shallow, so as not to interfere with the intended action of the tool. For example, with respect to a snow shovel, with a smaller radius, not only would the points between the scallops be sharp and more prone to wear, but rows of snow would be left behind. Thus, in all embodiments, it is preferred that the radius of the scallop be greater than one-half the distance between the forward-most “points,” and, in the preferred embodiments, that the radius of the scallop be equal to or greater than the distance between the forward-most “points” of a particular scallop. The word “points” is placed in quotation marks because it is not necessary to the invention that these points be sharp and, in fact, may be rounded upon manufacturer or through use.

FIGS. 2-5 illustrate different embodiments of the invention applied to different types of tools, and, in particular, with FIG. 2 depicting generally at 200 a shovel having a scoop 204 with optional ridges 206 suited for the transfer of heavier materials, including rock, sand, and so forth. As mentioned earlier, the type of handle provided for any tool described herein may vary, such that “D” type handle 102 may be more appropriate to the shovel shown in FIG. 2.

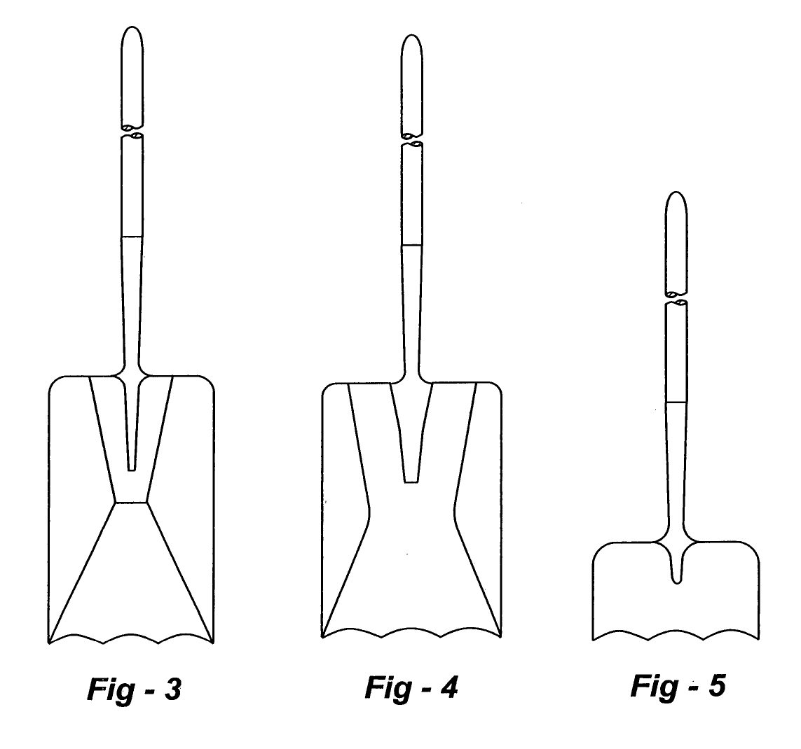

FIGS. 3, 4 and 5 illustrate, respectively, a garden spade, a square-point shovel, and an ice scraper constructed in accordance with this invention. Note, in these cases, since the width of the blade is on the order of six to ten inches, three scallops as opposed to a larger number would be more appropriate. As shown in FIG. 6, a leading edge 602 having scallops may be attached to a scoop portion 604 using, for example, rivets, screws, or other fasteners 606. This would not only allow for a replaceable leading-edge portion through use, but would also allow dissimilar materials, such as a scoop portion 604 made of aluminum, plastic, or the like, with a leading-edge portion 602 being made of hardened steel or other metal.

1. An improved blade for a shovel, comprising:
a scoop portion having a width, a length, and a leading edge;
a plurality of concave scallops on the leading edge; and
each scallop defining a segment of a single circle;
wherein the segments intersect at distinct forward points.

2. The improved shovel of claim 1, wherein:
the width of the scoop portion ranges between 6 and 24 inches; and
the number of scallops ranges between 3 and 12.

3. The improved shovel of claim 1, wherein:
the points are spaced apart by a distance ‘d’; and
the radius of each scallop, ‘r,’ is greater than d/2.

4. The improved shovel of claim 1, wherein:
the points are spaced apart by a distance ‘d’; and
the radius of each scallop, ‘r,’ is substantially equal to ‘d’.

5. The improved shovel of claim 1, wherein:
the spaced are apart by a distance ‘d’; and
the radius of each scallop, ‘r,’ is greater than ‘d’.

6. The improved shovel of claim 1, wherein the scallops are substantially identical.

7. The improved shovel of claim 1, wherein the scoop portion is configured for snow shoveling.

8. The improved shovel of claim 1, wherein the scoop portion includes stiffening ribs gardening.

10. The improved shovel of claim 1, wherein the scoop portion is configured for ice scraping.

11. The improved shovel of claim 1, wherein the leading edge is attached to the scoop portion.

12. The improved shovel of claim 1, wherein the leading edge and scoop portion are constructed form dissimilar materials.
